(19) United States
(12) Patent Application Publication
(10) Pub. No.: US 2009/0184042 A1
(43) Pub. Date: Jul. 23, 2009

(54) FILTER DEVICE

(75) Inventors: John Zachary Steed, Deer Isle, ME (US); Joshua Numa Guyot, Deer Isle, ME (US)

Correspondence Address: CHRIS A. CASEIRO, VERRILL DANA, LLP, ONE PORTLAND SQUARE, PORTLAND, ME, 04112-0586, US

(73) Assignee: Guyot Designs, LLC, Deer Isle, ME (US)

(21) Appl. No.: 12/358,978

(22) Filed: Jan. 23, 2009

Related U.S. Application Data
(60) Provisional application No. 61/022,927, filed on Jan. 23, 2008.
(60) Provisional application No. 61/087,014, filed on Aug. 7, 2008.

(51) Int. Cl. B01D 35/30

(52) U.S. Cl. 210/232

(57) ABSTRACT

A filter device removably retainable within a bottle for filtering fluid passing out of the bottle. The filter device is arranged to be insertable into any bottle. The filter device includes an insert component and a filter cartridge component. The insert includes an inlet and an outlet. It enables removable insertion into the bottle mouth with an interface sufficient to ensure that fluid cannot easily leak out around the sides of the device when in use. The filter cartridge is arranged to retain one or more filter media therein. It includes a fluid entry configured to direct fluid from within the bottle to come into contact with the filter media prior to its passage to the outlet. The filter device may be formed as a unitary structure or as a multi-component structure.

### CROSS REFERENCE TO RELATED APPLICATIONS

The present application claims the priority benefit of U.S. provisional patent application Ser. No. 61/022,927 filed Jan. 23, 2008, entitled FILTER INSERT FOR CONTAINER and U.S. provisional application Ser. No. 61/087,014 filed Aug. 7, 2008, entitled FILTER DEVICE, both by the same named inventors of the present application. The entire contents of both provisional applications are incorporated herein by reference.

### BACKGROUND OF THE INVENTION

1. Field of the Invention

The present invention relates to in situ filters for liquid containers. More particularly, the present invention relates to filters for filtering matter from liquids contained in bottles. Still more particularly, the present invention relates to filters for water bottles.

2. Description of the Prior Art

Many water bottles are available on the commercial market. One supplier of such products, Nalgene, is a well-known source of rigid one-liter plastic water bottles that include a threaded cap designed to couple with threads on the mouth of the bottle. The user can simply place a beverage of interest into the bottle via the mouth. The cap is designed to retain the beverage within the bottle. The cap may include some means of enabling the user to drink from the bottle without unintended spillage. A user may, for example, fill the bottle with water from a source including, but not limited to a tap linked to a public water supply.

While the water available from public water supplies is safe to drink, there is increasing interest in treating that water to remove impurities that may give the water an unpleasant appearance and/or an unpleasant taste or odor. For that reason, there exist in the marketplace filters that may be applied directly to the tap. See, for example, filters made available by the Brita Company. In many cases, these filters have a pre-filter reservoir and a post-filter reservoir, the combination of which require the user to wait for the filtering process to be completed before being able to access the filtered water.

It is desirable for an individual using a water bottle with a tap that has no such filter, to have a filter for the bottle itself. In that regard, there are in-bottle filter devices that exist that are positioned in the vicinity of the bottle's mouth. There are two basic ways that they work. First, some in-bottle filters are limited to use in flexible squeeze bottles, either in the form of a typical disposable PET water bottle or a HDPE bottle similar to bike bottles. The filter is a cylindrical extruded solid-block activated carbon filter that fits into the mouth of the bottle. The water is forced through the filter by squeezing of the flexible bottle. Such a filter does not work in a rigid bottle. The second type of existing in-bottle filter involves the use of a straw with a built-in filter. The straw arrangement may be of limited value, can interfere with a cap and generally undesirable for a user. In both instances, the filtering medium may be activated carbon. Other filter media are also available.

What is needed is an in-bottle filter suitable that is effective, suitable for use in a rigid bottle, does not interfere with operation of the cap and the filling of the bottle.

### SUMMARY OF THE INVENTION

The present invention solves the problems associated with prior in-bottle filters for rigid bottles. In particular, the invention is a filter device that is removably retainable within the bottle at the opening of the mouth of the bottle. The filter device is arranged to be insertable into any bottle. The filter device includes means for removable insertion into the bottle mouth, preferably with a fit sufficient to ensure minimal fluid leakage around the sides of the device at its interface with the interior of the bottle. The filter device also includes an inlet for receiving fluid, an outlet for the fluid to exit the bottle after filtering and a filter cartridge for removably retaining filter media therein. The filter cartridge includes a fluid entry configured to direct fluid from within the bottle to come into contact with the filter media prior to its passage to the outlet. The filter device may be formed as a unitary structure or as a multi-component structure.

The filter device may be fabricated as a rigid, relatively inflexible or a flexible structure, or some portions may be flexible and some relatively inflexible. The filter device is arranged to be unobtrusive within the bottle such that any bottle cap may be used unimpeded to close the bottle. Further, it is arranged for ease of use such that the bottle user may simply fill the bottle and drink fluid from it in substantially the same as when the filter device is omitted from the bottle.

In a first embodiment of the present invention, the filter device is formed as a unitary structure. The device fits into the mouth of most any shaped bottle and is configured with sufficient characteristics to establish preferably a substantially watertight fit with the bottle. It may be removed when desired, such as to clean, and/or fill or refill and/or to replace the filter media, which may be retained in a filter retainer. As noted, the device includes a fill port for filling the bottle with a fluid, such as tap water. The device also includes a drink port through which the user accesses fluid from within the bottle subsequent to its passage through the filter media. It is to be understood that the device may be configured so that there is a single port through which unfiltered fluid may enter the bottle and through which filtered fluid may exit the bottle. In this single-port configuration, the device is arranged so that fluid within the bottle must first pass through the filter before exiting the port.

The first embodiment of the device may be fabricated of any non-hazardous material, such as a nonmetallic material. Silicone has been found suitable for this purpose and is the preferred material for fabrication of at least a portion of the device. The filter cartridge includes means for inserting and removing the filter media, which itself may be contained in a filter container.

In a second embodiment of the present invention, the filter device is formed of two components comprising a flexible insert and a filter cartridge removably contained therein. The insert fits into the mouth of the bottle and is configured with sufficient frictional fit that it stays in the mouth throughout usage. Nevertheless, it may be removed when desired, such as to clean, and/or fill or refill and/or to replace the cartridge. The insert includes a fill port for filling the bottle with liquid, such as tap water. The insert also includes a drink port through which the user accesses water from the bottle subsequent to its passage through the filter. In a third embodiment, the insert of a two-component form of the filter device may be something other than flexible, including semi-rigid or rigid. In that embodiment, the insert is preferably shaped to conform substantially to the interior of the bottle at its intended position.

With continued reference to the two-component embodiment of the filter device including a flexible insert, the insert may be fabricated of any non-hazardous material, such as a nonmetallic material. As noted with respect to the first embodiment, silicone has been found suitable for this purpose and is the preferred material for fabrication of the insert. As noted, the silicone insert installs into the mouth of the bottle with a friction fit. The silicone piece can also flex to accommodate the variations in interior diameters found in various wide-mouth bottles. The replaceable filter cartridge is arranged for removable insertion into the silicone insert as described herein.

The bottle can be filled with the filter device in place but, unlike other filter arrangements, it does not require the user to wait for the water to pass from a pre-filter reservoir to a post-filter reservoir. The fluid device does not impede the ordinary process of drinking from the drink port. The fill port used to fill the bottle with the fluid allows air into the bottle while the user is drinking from the drink port so there is no vacuum pressure resistance during the drinking process. In some embodiments of the filter device, the device is arranged so that it will not interfere with the functioning of a lid that may be used to close the bottle. In one version of the invention, the filter device is completely containable within the bottle so that it has no direct interface with the lid. In another version of the invention, the filter device may be attached to, or formed integrally with, a lid structure. The filter device may also interface with the bottle in a manner that may enable effective filtering but that may also interfere with lid function. In this arrangement, the filter device may be inserted for filtering purposes and removed after the filtering process when covering the bottle with a lid is of interest. The filter device is an add-on for existing bottles, it is not part of an existing bottle, nor does it require a specific bottle structure. Nevertheless, it may be configured for permanent positioning within the bottle if that is of interest. It is contemplated that the filter may be fabricated in different sizes and shapes as needed to accommodate bottles with unusual shapes, sizes and structural limitations.

The filter medium used in the filter device of the first embodiment and in the removable filter cartridge of the second and third embodiments may be activated carbon, which acts at least to neutralize chlorine and to trap volatile organic compounds, but the filter medium is not limited thereto. The filter cartridge portion of the device is preferably arranged so that fluid can only exit the bottle by first passing through the filter media. The filter cartridge includes a cavity (or chamber) for retaining the filter media, which media may be replaced.

The filter device of the present invention allows a user to filter water or any other selected fluid that is contained in a bottle, such as a rigid bottle, without making any modification to the bottle, apart from inserting the filter device in the bottle's mouth. The filter media may be replaced. It does not interfere with ordinary bottle filling or with drinking. These and other advantages of the invention will be apparent upon review of the following detailed description, the accompanying figures and the appended claims.

### BRIEF DESCRIPTION OF THE FIGURES

FIG. 1 is a perspective view of a first embodiment of the filter device of the present invention.

FIG. 2 is a cross sectional view of the filter device of the first embodiment.

FIG. 3 is a side view of a portion of a bottle showing a second embodiment of the filter of the invention in cross sectional side view and illustrating the water flow path into the bottle.

FIG. 4 is a side view of a portion of a bottle showing the second embodiment of the filter device in cross sectional side view and illustrating the water flow path out of the bottle.

FIG. 5 is a top perspective view of the bottle showing the second embodiment of the filter device in situ.

FIG. 6 is a perspective view of an embodiment of the filter cartridge of the second embodiment of the filter device.

FIG. 7 is a cross sectional side view of the second embodiment of the filter device comprising the insert and the filter cartridge of FIG. 5.

FIG. 8 is a bottom perspective view of a third embodiment of the filter device of the present invention.

FIG. 9 is an exploded bottom perspective view of the third embodiment of the filter device showing the bottle insert and the removable filter cartridge separated from one another.

FIG. 10 is a cross-sectional perspective side view of the third embodiment of the filter device in situ in the bottle.

FIG. 11 is a cross-sectional side view of the third embodiment of the filter device in situ in the bottle.

### DETAILED DESCRIPTION OF A PREFERRED EMBODIMENT OF THE INVENTION

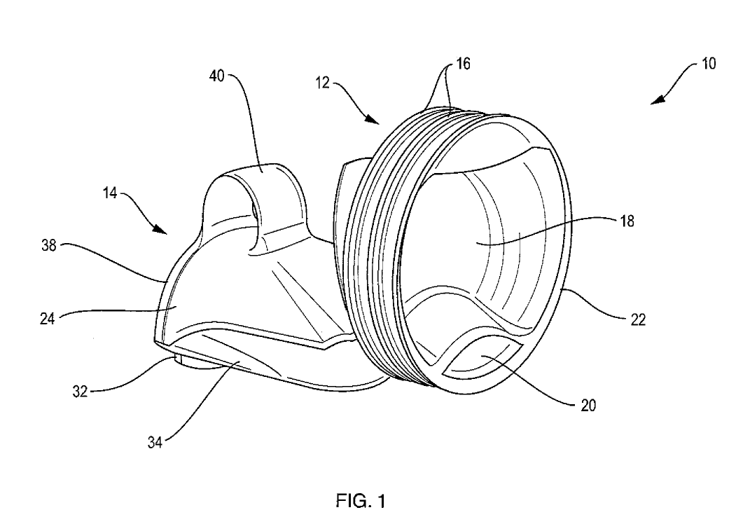

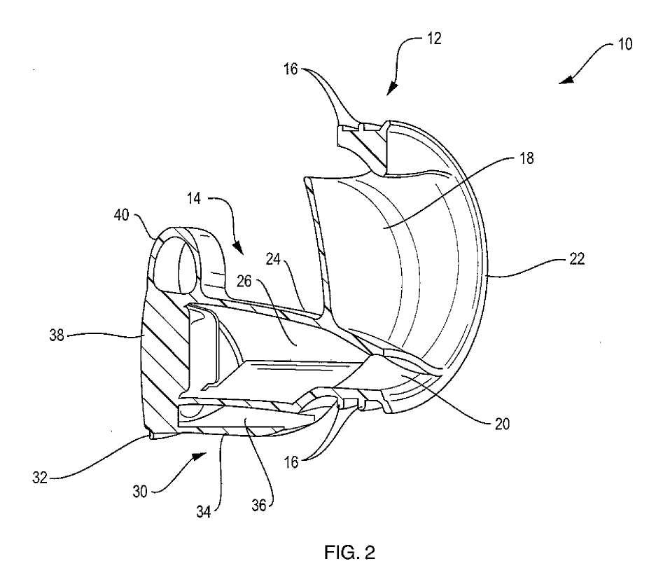

As illustrated in FIGS. 1 and 2, a first embodiment of the present invention, which is a filter device 10 including a bottle interface portion 12 and a filter cartridge 14. The bottle interface portion 12 is arranged to engage with the interior of the mouth of a bottle in a watertight frictional fit but is also removable from the interior of the bottle. The filter cartridge 14 is joined to the interface portion 12 and includes a space for retaining filter media therein. The filter cartridge 14 is configured to fit within the interior of most any shaped bottle. The filter device 10 is fabricated as a unitary structure formed of silicone. However, it is to be understood that the filter device 10 may be fabricated as a multi-component device and may be fabricated of one or more other materials. As used herein, the term “bottle” means any form of container for retaining one or more fluids therein.

The interface portion 12 of the filter device 10 includes one or more friction fit structures, such as ribs 16 that are sufficiently compressible, flexible or otherwise compliant so as to establish a watertight frictional fit when contacting the interior of the bottle. The interface portion 12 includes a fluid entry port 18 spaced from a filtered fluid exit port 20 by an interface top 22. When the filter device 10 is positioned in the bottle, the bottle may be filled with fluid by directing water to the fluid entry port 18. The top 22 may be inset and/or fabricated with a bias toward the fluid entry port 18 such as by having a tilted configuration from the exit port 20 toward the entry port 18, to capture any fluid that does not fall directly into the bottle and direct that fluid from the top 22 to the entry port 18.

The filter cartridge 14 includes a filter body 24 with a cavity 26 for removably retaining therein a filter medium (not shown). The cavity 26 is in communication with the exit port 20 by way of cartridge exit 28. The cavity 26 is also in communication with the interior of the bottle (not shown) by way of filter entry 30. The cartridge entry 30 includes a standoff tab 32 or other means for spacing the filter cartridge 14 from the interior surface of the body of the bottle. The cartridge entry 30 also includes flange 34 and cartridge inlet port 36. The inlet slot 36 is in communication with the cavity 26 of the filter cartridge 14. The standoff tab 32 allows fluid within the bottle to pass between the bottle interior wall and the exterior of the flange 34. The standoff tab 32 may not be required for certain bottle configurations in which the filter body 24 already stands off from the interior of the bottle. The fluid passes the flange 34 before entering the cartridge inlet port 36, which is arranged as a slot in the embodiment shown, then on to the cavity 26.

The filter cartridge 14 also includes a removable base 38 and a base retaining tab 40. The removable base 38 is arranged for a frictional fit with the filter body 24. The cavity 26 of the filter body 24 is accessed through an opening established by decoupling the base 38 from the filter body 24. A filter medium (not shown) retained in the cavity 26 is inserted into or removed from the cavity 26 by way of the opening otherwise closed by the base 38. The filter media may be contained in a reusable or recyclable container, such as a bag, for example. The base 38 is joined to the filter body 24 by retaining tab 40, which may be a flexible flap, for example, but is not limited thereto.

The filter device 10 of the present invention may be used in a wide range of bottles. It includes a filter media retainer and a bottle interface that together allow a user to easily filter a fluid of interest without interfering impact on the ordinary usage of the bottle. Those skilled in the art will recognize reasonable variants of the embodiment of the filter device 10 described herein.

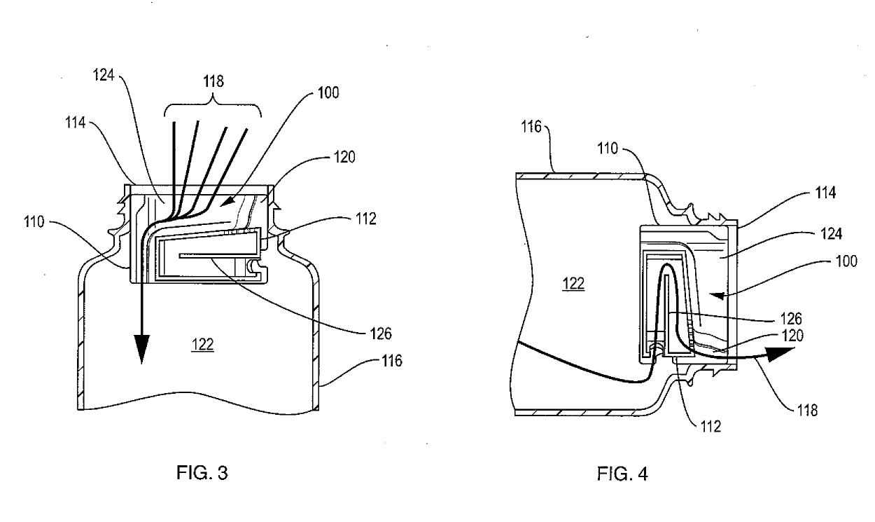

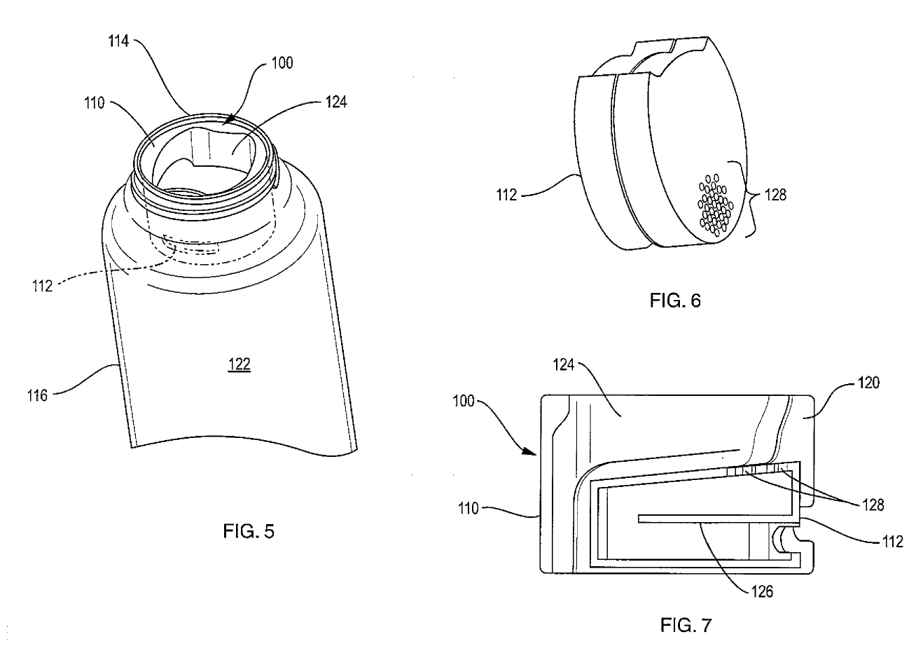

FIGS. 3-7 illustrate a second embodiment of the present invention, which is a filter device 100 arranged as a two-component device including an insert 110 and a filter cartridge 112. The filter device 100 is removably placeable into a mouth 114 of a bottle 116. The filter device 100 is configured for placement into or over the opening at the mouth 114 of the bottle 116 to enable exiting liquid 118 to pass therethrough via drink port 120, as shown in FIG. 4. The filter device 100 further allows the liquid 118 to enter into the bottle's storage area 122 via entry port 124 while bypassing the filter cartridge 112, as shown in FIG. 3. The filter device 100 may fit into the bottle opening via the mouth 114 with a friction fit and is preferably separate from both the bottle 116 and its lid. In this embodiment, the filter cartridge 112 is a removable unit that fits into the insert 110 and contains a filter medium (not shown). It also provides structural support to the insert 110 and is arranged to channel liquid in a manner to maximize liquid contact with the filter medium contained therein. For example, as shown in FIGS. 3-7, the filter cartridge 112 includes a baffle 126 that forces water to proceed on a circuitous route prior to exiting the cartridge 112 through a plurality of cartridge ports 128.

While the filter device 100 is shown in the first embodiment of the accompanying figures as a two-component device, it is to be understood that the filter device 100 may be a unitary structure including an entry port, a drinking port and an interior section including filter means. The filter means may be a cavity of some form containing one or more filtering media. The cavity is preferably arranged such that liquid entering the bottle via the entry port 124 does not pass into the cavity. Instead, only liquid exiting from the interior of the bottle 116 passes into the cavity and thus, through the filter media via the filter cartridge 112. Further, as indicated, the filter device 100 may be a unitary or multi-component device and it may be substantially, partially or completely flexible, or any part thereof may be substantially, partially or completely flexible. Those skilled in the art will recognize reasonable variants of the second embodiment of the in-bottle filter device 100 described herein.

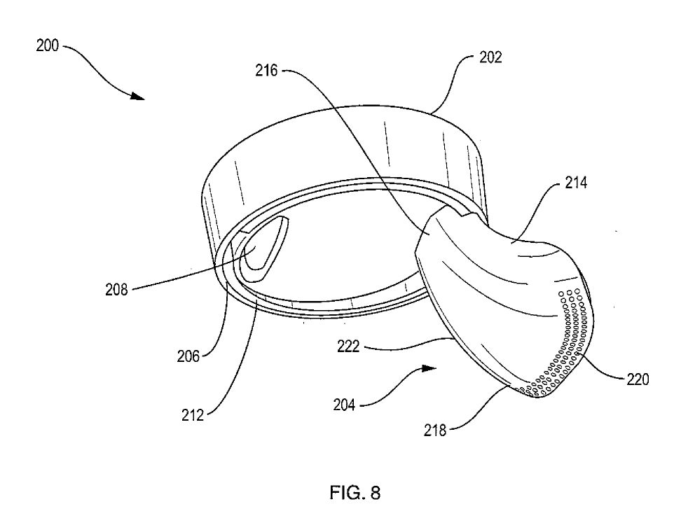

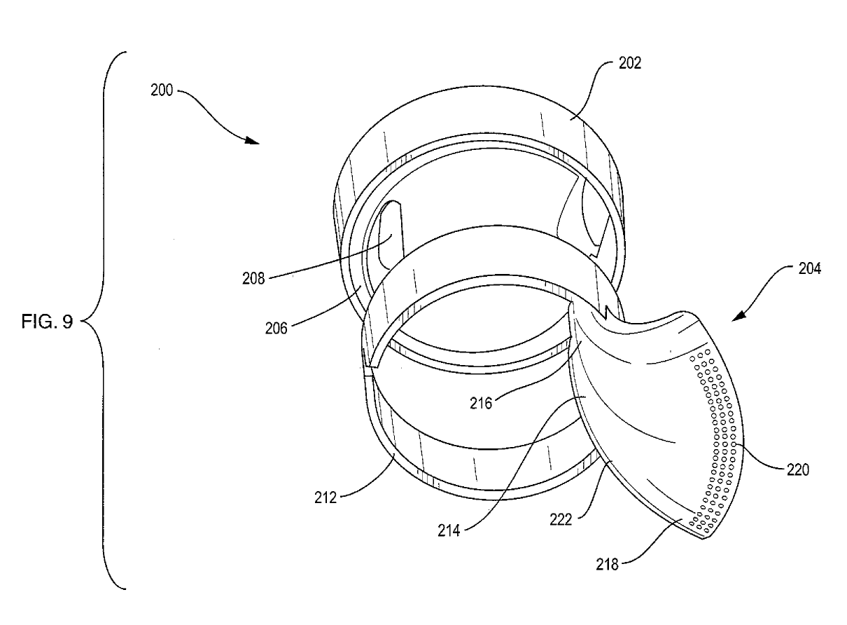

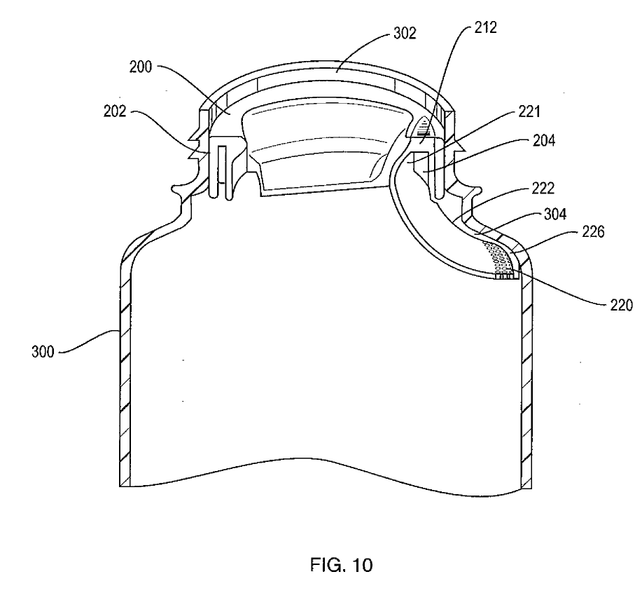

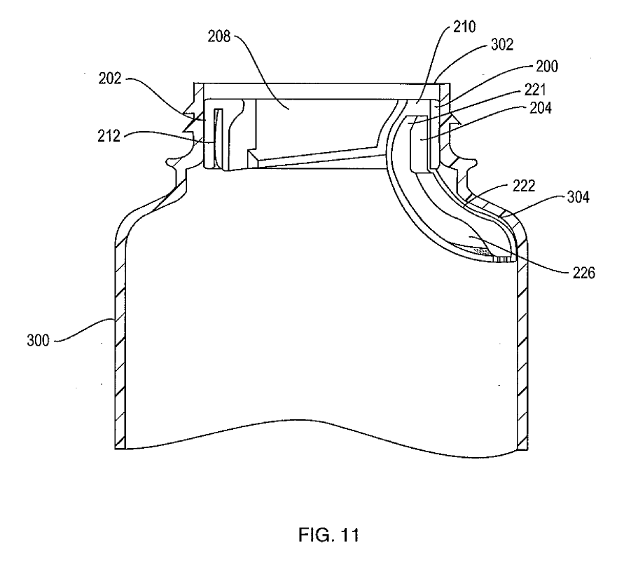

A third embodiment of the filter device is represented as filter device 200 in FIGS. 8-11. In the third embodiment, the filter device 200 includes a bottle insert 202 and a filter cartridge 204 that is removably insertable into the insert 202. The bottle insert 202 includes an outer surface for removable engagement, such as by frictional contact, with an inner surface of mouth 302 of bottle 300. The bottle insert 202 also includes an annular slot 206 for retaining the filter cartridge 204 therein as a means for coupling the insert 202 and the filter cartridge 204 together, a fluid entry port 208 for receiving fluid into the bottle 300, and a fluid exit port or drink port 210 through which an individual draws fluid from within the bottle 300 via the filter cartridge 204.

The filter cartridge 204 includes an interface ring 212 sized and shaped for removable frictional fit within the slot 206 of the insert 202. The filter cartridge 204 further includes an extension section 214 having a first end 216 attached to or forming part of the ring 212 and a second end 218 terminating with one or more cartridge entry ports 220 by which unfiltered liquid within the bottle 300 enters the filter cartridge 204. The liquid passes through the filter cartridge 204 before exiting via cartridge exit port 221 then to the drink port 210 of the insert 202. The extension section 214 is configured with an intermediate curved region 222 of a shape suitable to position the extension section 214 of the filter cartridge 204 adjacent to the interior of a shoulder 304 of the bottle 300 when the filter device 200 is positioned in the mouth 302 of the bottle 300. Specifically, the filter device 200 is arranged such that the cartridge ports 220 open to the interior of the bottle 300 at or about just below the interior of the shoulder 304.

The extension section 214 of the filter cartridge 204 is hollow, partially hollow, or otherwise configured to include cavity 226 for retaining therein one or more filter media (not shown), in the manner described with regard to the second embodiment of the filter device. The cavity 226 is preferably arranged such that liquid entering the bottle 300 via the entry port 208 does not pass into the cavity 226. Instead, only liquid exiting from the interior of the bottle 300 passes into the cavity 226 and thus, through the filter media via the filter cartridge 204. As with the second embodiment of the filter device 100, the filter device 200 may be a unitary or multi-component device and it may be substantially, partially or completely flexible, or any part thereof may be substantially, partially or completely flexible. The arrangement of the extension section 214 ensures that the user may access the liquid contained in the bottle 300 without disruption as the liquid level in the bottle 300 is reduced. Those skilled in the art will recognize reasonable variants of the third embodiment of the in-bottle filter device 200 described herein.

The filter device of the present invention is suitable for use with a range of containers. It may be incorporated into the container's opening and does not impede the flow of liquid therein. In addition, the filter device allows the user to drink the liquid contained within the container with minimal delay while also ensuring that the liquid passes through the filter medium prior to exiting the container. Although the focus of the description of the present invention has been directed to a removable device, it is contemplated that one or more embodiments of the filter device may be permanently affixed within or integrally formed with the bottle. In such an alternative arrangement, the filter cavity is preferably configured to remain accessible for removing or adding filter media, within the bottle, or the filter may be some form of permanent filter wherein the filter medium may not be accessible within the bottle.

The embodiments of the filter device have been described with a frictional fit between the device and the interior of the bottle contemplated. However, the filter device may be fabricated with different arrangements for joining the device to the bottle. For example, but not limited thereto, an upper exterior surface of the device may be threaded to match interior threading of the bottle. In that way, the filter device may be screwed to and unscrewed from the interior of the bottle. Alternatively, the filter device may include at its upper portion internal threading arranged to match exterior threading of the mouth of the bottle so that it may be removably affixable to the bottle in that way. Such an arrangement may include additional exterior threading at the upper portion of the filter device for the purpose of matching internal threading of a lid structure. It is to be understood by those of ordinary skill in the art that other means for removably joining the filter device to the bottle may be employed. Further, as previously noted, the filter device may optionally be permanently joined to the bottle.

The embodiments of the filter device have also been described as making the invention a component distinct from a bottle lid. In an alternative arrangement, the filter device may include a permanent or removable lid structure such that either or both of the filter device and the lid structure may be joined to the bottle. In one example of such an embodiment of the invention, the filter device is configured with dimensions sufficient to fit it within the bottle opening. That filter device may form part of, or be removably affixable to the lid structure, and that lid structure affixable to the bottle opening, such as by frictional fit, screw top, or the like. In this embodiment, the filter device remains arranged to ensure that it does not interfere with the lid function. Further, the lid/filter device combination may be arranged to include one or more covers for one or more ports of the lid. The covers may be joined to the lid but movable so that they may be manipulated to access or close the one or more ports for entry to and exit from the interior of the bottle.

While the filter device has generally been described in a manner that contemplates avoidance of interference with the use of a lid, it may optionally be joined to the bottle in a manner that may otherwise interfere with lid function. For example, the filter device may be removably joined to the exterior of the bottle in a way that would interfere with the use of a lid, such as by having internal threading to match external threading of the bottle. In this embodiment, the filter device may be used to filter fluid and then removed when the filtering process is completed, including after a drink has been taken, so that a lid may be applied to the bottle if that is of interest.

The embodiments of the filter device have also been described with two ports; one for unfiltered fluid entry to the interior of the bottle and one for drinking of filtered fluid. In an alternative embodiment of the invention, the filter device including, but not limited to, an embodiment including the joined lid structure, may have a single port. In this embodiment, the bottle may be filled or partially filled by directing unfiltered fluid through the single port. The filter device is arranged so that the fluid entering the interior of the bottled through the single port bypasses the filter component of the filter device. Upon completion of the filling or partial filling, the bottle may be used to drink fluid by tipping the bottle so that the fluid exits the single port. Prior to exiting, the fluid passes through the filter component of the filter device. The filter device in this embodiment may include a plurality of chambers arranged to allow fluid to pass through an entry chamber and exit through a filter chamber. In an alternative of this embodiment, the filter device may include a baffle configured to direct entering fluid into the interior of the bottle via a first pathway and to direct exiting fluid through the filter component via a second pathway distinct from the first pathway.

While the present invention has been described with respect to several specific embodiments, it is to be understood that various modifications may be made to the filter device without departing from the spirit and scope of the invention. Accordingly, other embodiments are within the scope of the claims appended hereto.

What is claimed is:

1. A filter device comprising:
a. an insert configured for removable engagement within a bottle, wherein the insert includes a fluid entry port and a fluid exit port; and
b. a filter cartridge coupled to the insert, wherein the filter cartridge includes a cavity arranged for containing therein a filter medium, one or more cartridge entry ports and a cartridge exit port,
wherein the insert and filter cartridge are arranged such that any fluid entering the bottle via the fluid entry port must first pass through the filter cartridge before exiting the bottle through the fluid exit port.

2. The filter device as claimed in claim 1 wherein the filter cartridge includes an intermediate curved region spaced between the one or more cartridge entry ports and the cartridge exit port.

3. The filter device as claimed in claim 2 wherein the intermediate curved region of the filter cartridge is configured to conform substantially to the interior surface of a shoulder of the bottle.

4. The filter device as claimed in claim 2 wherein the intermediate curved region is at least partially hollow and is configured to contain the filter medium therein.

5. The filter device as claimed in claim 1 further comprising a bag for retaining the filter medium therein, wherein the bag is selected to fit within the filter cartridge.

6. The filter device as claimed in claim 1 wherein the filter cartridge includes a removable base arranged to allow access to an interior portion of the filter cartridge.

7. The filter device as claimed in claim 1 wherein the insert includes an annular slot and the filter cartridge includes a ring configured for a removable joining of the filter cartridge with the insert within the annular slot of the insert.

8. The filter device as claimed in claim 1 wherein the insert includes an outer surface configured to establish a removable connection with an inner surface of a mouth of the bottle.

9. The filter device as claimed in claim 1 wherein the insert and the filter cartridge are fabricated of one or more non-metallic materials.

10. The filter device as claimed in claim 1 wherein the filter cartridge includes a standoff tab configured to space the filter device away from an interior surface of the bottle when the filter device is positioned within the bottle.

11. The filter device as claimed in claim 1 wherein the insert is of a tilted configuration arranged such that the fluid exit port is oriented above the fluid entry port.

12. The filter device as claimed in claim 1 wherein the filter cartridge is configured to maximize the fluid pathway therethrough.

13. The filter device as claimed in claim 12 wherein the filter cartridge includes a baffle for regulating fluid flow therein.

14. The filter device as claimed in claim 1 wherein the insert and the filter cartridge comprise a unitary structure.

15. The filter device as claimed in claim 1 wherein the fluid entry port and the fluid exit port comprise a single port.

16. The filter device as claimed in claim 1 further comprising a bottle lid structure that may be joined to the insert.

17. The filter device as claimed in claim 16 wherein the insert is formed integrally with the bottle lid structure.
